(19) United States
(12) Patent Application Publication
(10) Pub. No.: US 2015/0036511 A1
(43) Pub. Date: Feb. 5, 2015

(54) METHOD OF INCREASING DATA THROUGHPUT OF A WIRELESS NETWORK SYSTEM BY DYNAMICALLY ADJUSTING MTU/FRAGMENTATION SIZE ACCORDING TO CURRENT TRANSMISSION STATUS

(71) Applicant: ACER INCORPORATED, New Taipei City (TW)

(72) Inventor: Tsung-Yo Cheng, New Taipei City (TW)

(73) Assignee: ACER INCORPORATED, New Taipei City (TW)

(21) Appl. No.: 14/246,136

(22) Filed: Apr. 6, 2014

Related U.S. Application Data
(60) Provisional application No. 61/862,092, filed on Aug. 5, 2013.

(51) Int. Cl. H04W 28/06; H04W 24/00; H04L 12/26; H04W 28/04; H04L 12/805

(52) U.S. Cl. CPC H04W 28/06; H04W 28/04; H04L 47/36; H04L 43/0829; H04W 24/00
USPC 370/242; 370/252

(57) ABSTRACT

In a wireless network system which adopts a multi-layer data transmission structure, a wireless channel is established between a user equipment and a base station. A wireless transmission channel is established between the user equipment and the base station. An MTU/fragmentation size adopted in the wireless transmission channel is set and dynamically adjusted according to the current transmission status of the wireless transmission channel.

### CROSS REFERENCE TO RELATED APPLICATIONS

This application claims the benefit of U.S. provisional application No. 61/862,092 filed on Aug. 5, 2013.

### BACKGROUND OF THE INVENTION

1. Field of the Invention

The present invention is related to a method of data transmission in a wireless network system having a multi-layer structure, and more particularly, to a method of increasing data throughput of a wireless network system by dynamically adjusting MTU/fragmentation size according to current transmission status.

2. Description of the Prior Art

With rapid development in technology, a user may easily connect to a network using desktop computers, notebook computers, personal digital assistants (PDAs) or smart phones. In order for electronic equipment having varying specifications to be able to communicate with other entities in the same network, an OSI (Open Systems Interconnection) network model has been provided by ISO (International Organization for Standardization) for managing the network intercommunication between two network entities.

Third generation (3G) and fourth generation (4G) wireless networks, as specified by the 3rd Generation Partnership Project (3GPP) include wireless access networks in which different application services, such as data services, voice over IP (VoIP) content or video content, can be delivered over various communication protocols, such as Internet protocol (IP) and Transmission Control Protocol (TCP). Both IP and TCP define size limits for packets transmitted over a network. The IP maximum transmission unit (MTU) defines the maximum size of IP packet that can be transmitted. The TCP maximum segment size (MSS) defines the maximum number of data bytes in a packet (excluding the TCP/IP headers).

In computer networking, the size of an MTU/fragmentation may be fixed according to the adopted network access interfaces (such as Ethernet, WLAN, Token Ring or FDDI) or determined by relevant systems (such as point-to-point serial links) at connecting time. A larger MTU/fragmentation size brings greater efficiency improves bulk protocol throughput because each packet carries more user data while protocol overheads remain fixed. A larger MTU/fragmentation size also means processing of fewer packets for the same amount of data, especially in a system where per-packet-processing is a critical performance limitation. However, large packets occupy a slow link for more time than a smaller packet, causing greater delays to subsequent packets, and increasing lag and minimum latency. Large packets are also problematic in the presence of communications errors since larger packets are more likely to be corrupt at a given bit error rate. Corruption of a single bit in a packet requires that the entire packet be retransmitted, and retransmissions of larger packets take longer due to greater payload.

Therefore, there is a need for a method of dynamically adjusting MTU/fragmentation size to optimize data throughput rate.

### SUMMARY OF THE INVENTION

The present invention provides a method of data transmission between a user equipment and a base station in a wireless network system having a multi-layer structure. The method includes establishing a wireless transmission channel between the user equipment and the base station; measuring a signal transmission status of the wireless transmission channel; and setting an MTU/fragmentation size adopted in the wireless transmission channel according to the transmission status.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-layer structure according to the OSI model.

FIGS. 2 and 8 are flowcharts illustrating methods of optimizing data throughput rate in a wireless network system according to embodiments of the present invention.

FIGS. 3-7 are diagrams illustrating methods of executing steps in the embodiment of FIG. 2.

### DETAILED DESCRIPTION

In the present invention, when a user equipment and a base station in a wireless network system are in communication using a multi-layer structure, the user equipment may dynamically adjust the MTU/fragmentation size according to its current transmission status, thereby improving the overall data throughput of the wireless network system.

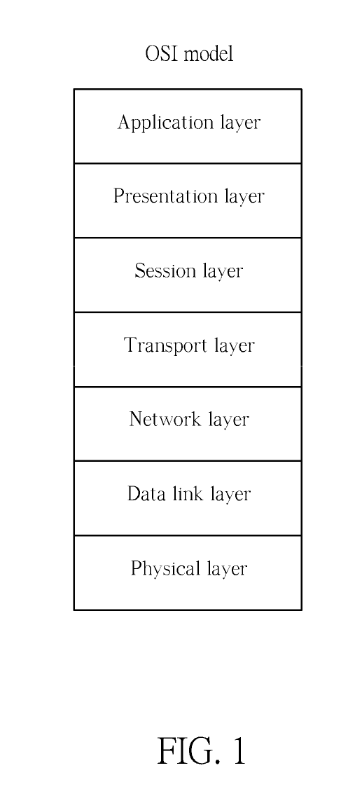

FIG. 1 is a diagram illustrating a multi-layer structure according to the OSI model. From bottom to top, Layer 1˜Layer 7 sequentially include physical layer, data link layer, network layer, transport layer, session layer, presentation layer, and application layer. The physical layer and the data link layer in the OSI model are configured to handle network hardware connection and may be implemented on various network access interfaces, such as Ethernet, Token-Ring or Fiber Distributed Data Interface (FDDI), etc. The network layer in the OSI model is configured to deliver messages between a transmitting entity and a receiving entity using various protocols, such as identifying addresses or selecting transmission path using IP, address Resolution Protocol (ARP), Reverse Address Resolution Protocol RARP or Internet Control Message Protocol (ICMP). The transport layer in the OSI model is configured to deliver messages between different hosts using TCP and User Datagram Protocol (UDP). The session layer, the presentation layer, and the application layer in the OSI model are configured to provide various application protocols, such as TELNET, File Transfer Protocol (FTP), Simple Mail Transfer Protocol (SMTP), Post Office Protocol 3 (POP3), Simple Network Management Protocol (SNMP), Network News Transport Protocol (NNTP), Domain Name System (DNS), Network Information Service (NIS), Network File System (NFS), and Hypertext Transfer Protocol (HTTP). The present invention may be applied to any wireless network system having a multi-layer structure for data transmission. Also, various communication standards, such as 2G, 3G or 4G, may be used to establish a wireless transmission channel between the user equipment and the base station in the wireless network system. However, the embodiment depicted in FIG. 1 and the types of the communication standard do not limit the scope of the present invention.

In the present invention, the user equipment may include transportable electronic devices such as mobile telephones, personal digital assistants, handheld, tablet, nettop, or laptop computers, or other devices with similar telecommunication capabilities. In other cases, the user equipment may include non-transportable devices with similar telecommunications capabilities, such as desktop computers, set-top boxes, or network appliances. The base station is configured to provide local coverage (an area where the user equipment can work) for the wireless network system. However, the types of the user equipment and the base station do not limit the scope of the present invention.

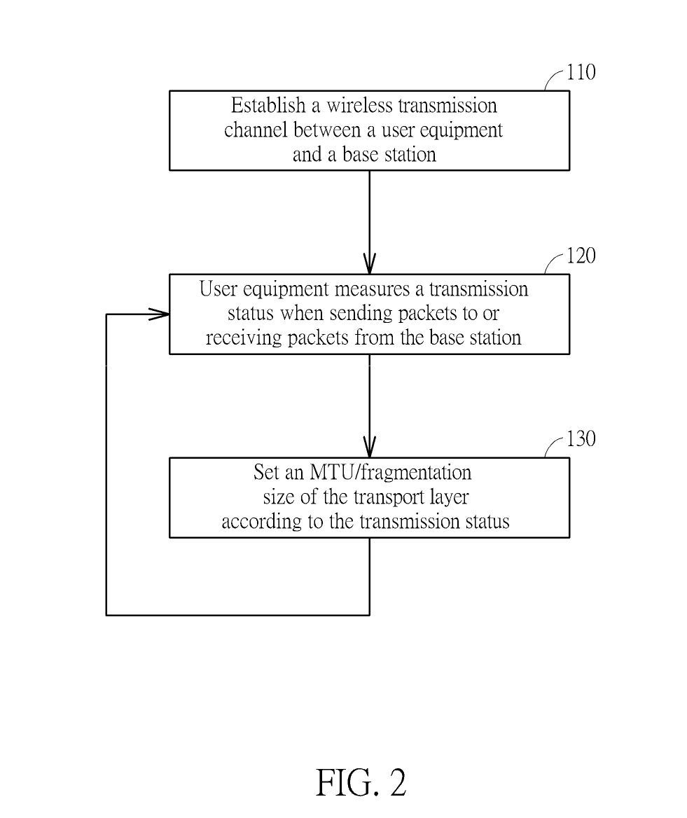

FIG. 2 is a flowchart illustrating a method of optimizing data throughput rate in a wireless network system according to an embodiment of the present invention. The flowchart in FIG. 1 includes the following steps:

Step 110: establish a wireless transmission channel between a user equipment and a base station in the wireless network system; execute step 120.

Step 120: user equipment measures a transmission status when sending packets to or receiving packets from the base station; execute step 130.

Step 130: set an MTU/fragmentation size of the transport layer according to the transmission status; execute step 120.

In the embodiment illustrated in FIG. 2, the transmission status may be acquired by measuring the packet loss rate of the packet error rate (PER) of the transport layer in step 120. The MTU/fragmentation size of the transport layer may be set according to the measured packet loss rate or PER in step 130.

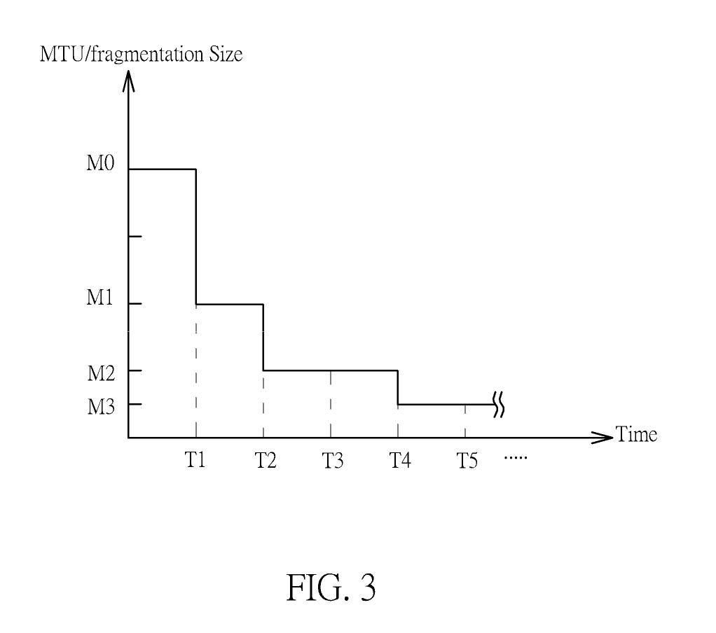

FIGS. 3-6 are diagrams illustrating methods of executing step 130 in the embodiment of FIG. 2. T1-T5 denote the time points at which the user equipment executes step 120. For illustrative purpose, assume that the MTU/fragmentation size of the transport layer is set to M0, which is the original/default MTU/fragmentation size of the transport layer, when executing step 110. Also, it is assumed that the packet loss rates or PERs measured at T1, T2 and T4 exceed a threshold value M_{TH}, while the packet loss rates or PERs measured at T3 and T5 do not exceed the threshold value M_{TH}.

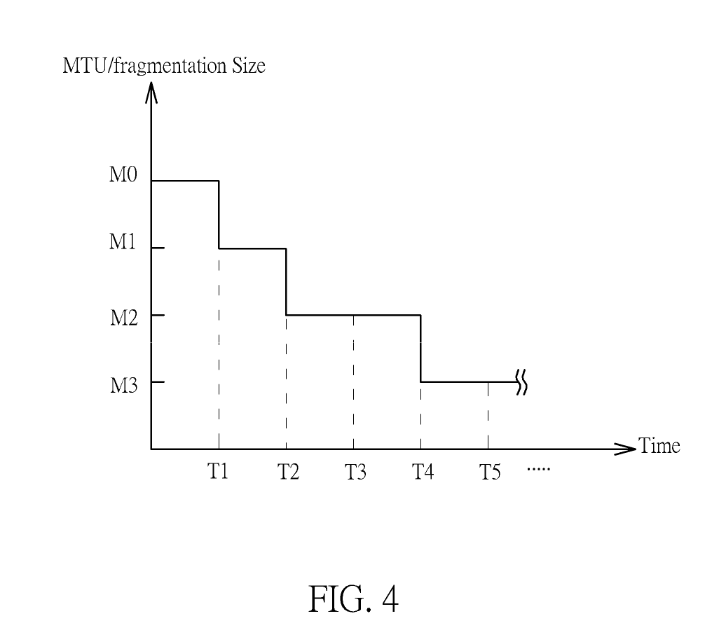

In the methods depicted in FIGS. 3 and 4, if the packet loss rate or PER measured at a specific time point does not exceed the threshold value M_{TH}, the MTU/fragmentation size of the transport layer is set to its current value at the specific time point in step 130; if the packet loss rate or PER measured at the specific time point exceeds the threshold value M_{TH}, the MTU/fragmentation size of the transport layer is set to an updated value smaller than its current value in step 130. More specifically, when the packet loss rate or PER measured at T1 exceeds the threshold value M_{TH}, the user equipment is configured set the MTU/fragmentation size of the transport layer to M1 before T2. When the packet failure rate measured at T2 still exceeds the threshold value M_{TH} after setting the MTU/fragmentation size to M1, the user equipment is configured set the MTU/fragmentation size of the transport layer to M2 before T3. When the packet loss rate or PER measured at T3 does not exceed the threshold value M_{TH} after setting the MTU/fragmentation size to M2, the user equipment is configured maintain the MTU/fragmentation size of the transport layer at M2 before T4. When the packet loss rate or PER measured at T4 again exceeds the threshold value M_{TH} after setting the MTU/fragmentation size to M2, the user equipment is configured set the MTU/fragmentation size of the transport layer to M3 before T5. Similar procedure may be repeated after T5.

The present invention may adopt any decrement method for setting the MTU/fragmentation size of the transport layer when executing step 130 in the embodiment of FIG. 2. For example, the MTU/fragmentation size of the transport layer may be set to an updated value which is half of its current value (i.e. M1=M0/2, M2=M1/2, and M3=M2/2), as depicted in FIG. 3. Or, the MTU/fragmentation size of the transport layer may be decremented by the same amount when necessary (i.e. |M1−M0|=|M2−M1|=|M3−M2|>0). However, the type of method used for setting the MTU/fragmentation size of the transport layer does not limit the scope of the present invention.

Since the MTU/fragmentation size of the transport layer may be lowered or maintained at its current value according the real-time transmission status, the present invention can improve the overall data throughput of the wireless system.

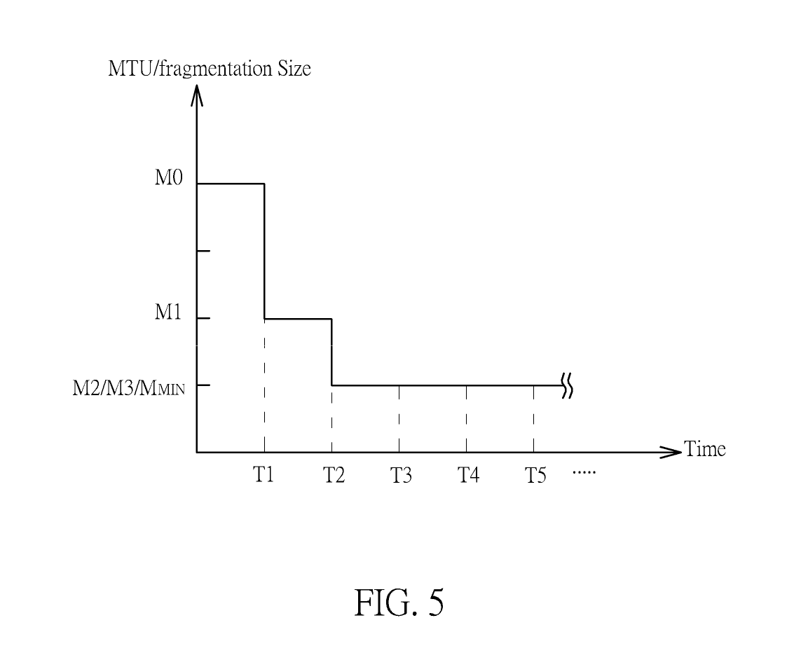

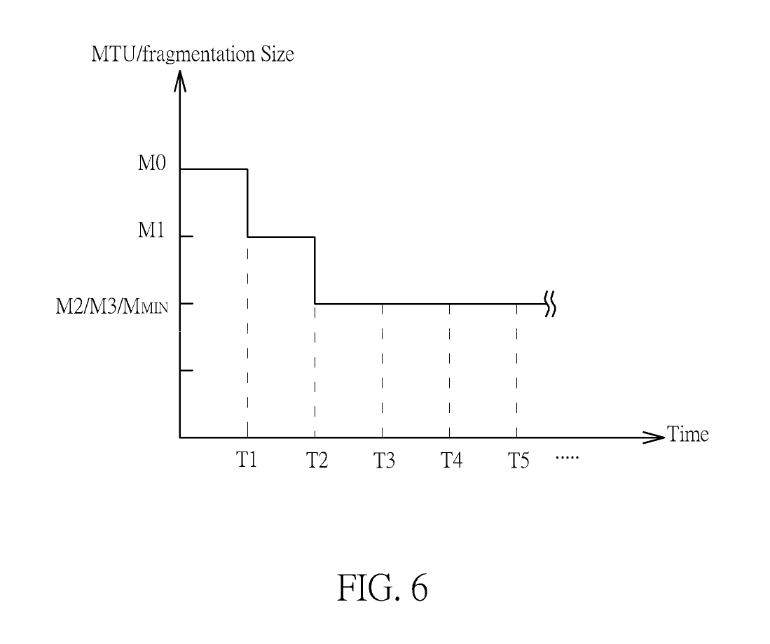

In the methods depicted in FIGS. 5 and 6, a minimum MTU/fragmentation size M_{MIN} is further introduced so that the updated value of the MTU/fragmentation size is not smaller than M_{MIN}. For example, if the minimum MTU/fragmentation size M_{MIN} is set to M0/4 and the MTU/fragmentation size of the transport layer is set to an updated value which is half of its current value when necessary, then M1=M0/2, M2=M0/4, and M3=M0/4, as depicted in FIG. 5. If the minimum MTU/fragmentation size M_{MIN} is set to M2 and the MTU/fragmentation size of the transport layer may be decremented by the same amount when necessary, then |M1−M0|=|M2−M1|>0 and M3=M2). However, the type of method used for setting the MTU/fragmentation size of the transport layer does not limit the scope of the present invention.

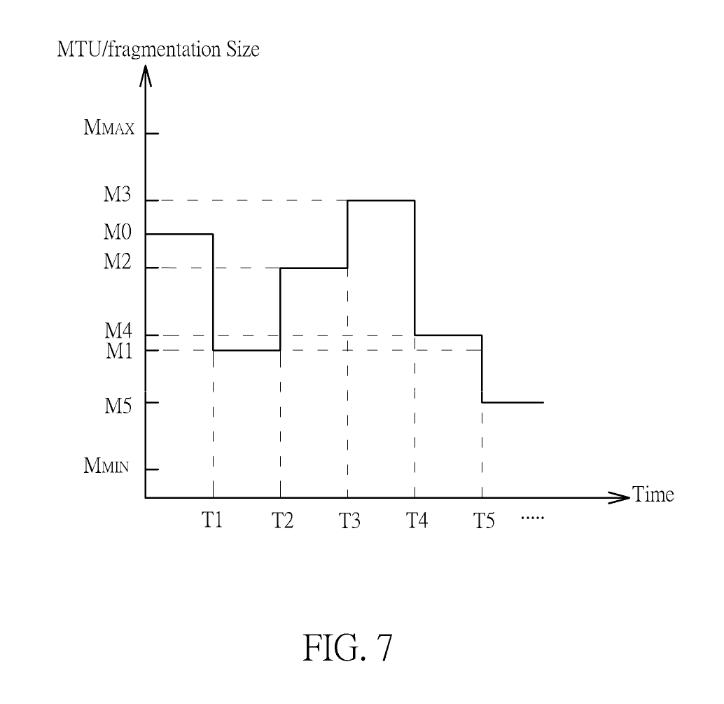

FIG. 7 is a diagram illustrating a method of executing step 130 in the embodiment of FIG. 2. T1-T5 denote the time points at which the user equipment executes step 120. For illustrative purpose, assume that the MTU/fragmentation size of the transport layer is set to Mo, which is the original/default MTU/fragmentation size of the transport layer, when executing step 110. Also, it is assumed that the packet loss rates or PERs measured at T1, T4 and T5 exceed the predetermined value, but the packet loss rates or PERs measured at T2 and T3 do not exceed the predetermined value at T3. A maximum MTU/fragmentation size M_{MAX} and a minimum MTU/fragmentation size M_{MIN} are introduced so that the updated value of the MTU/fragmentation size is between M_{MAX} and M_{MIN}.

In the method depicted in FIG. 7, if the packet loss rate or PER measured at a specific time point does not exceed the threshold value M_{TH}, the MTU/fragmentation size of the transport layer is set to an updated value which is the average of M_{MAX} and its current value at the specific time point in step 130; if the packet loss rate or PER measured at the specific time point exceeds the threshold value M_{TH}, the MTU/fragmentation size of the transport layer is set to an updated value which is the average of M_{MIN} and its current value at the specific time point in step 130. More specifically, when the packet loss rate or PER measured at T1 exceeds the threshold value M_{TH}, the user equipment is configured set the MTU/fragmentation size of the transport layer to M1 before T2, wherein M1=(M0+M_{MIM})/2. When the packet loss rate or PER measured at T2 does not exceed the threshold value M_{TH} after setting the MTU/fragmentation size to M1, the user equipment is configured set the MTU/fragmentation size of the transport layer to M2 before T3, wherein M2=(M1+M_{MAX})/2. When the packet loss rate or PER measured at T3 does not exceed the threshold value M_{TH} after setting the MTU/fragmentation size to M2, the user equipment is configured set the MTU/fragmentation size of the transport layer to M3 before T4, wherein M3=(M2+M_{MAX})/2. When the packet failure rate measured at T4 again exceeds the threshold value M_{TH} after setting the MTU/fragmentation size to M3, the user equipment is configured set the MTU/fragmentation size of the transport layer to M4 before T5, wherein M4=(M3+M_{MIN})/2. When the packet loss rate or PER measured at T5 still exceeds the threshold value M_{TH} after setting the MTU/fragmentation size to M4, the user equipment is configured set the MTU/fragmentation size of the transport layer to M5, wherein M5=(M4+M_{MIN})/2. Similar procedure may be repeated after T5. However, the type of method used for setting the MTU/fragmentation size of the transport layer does not limit the scope of the present invention.

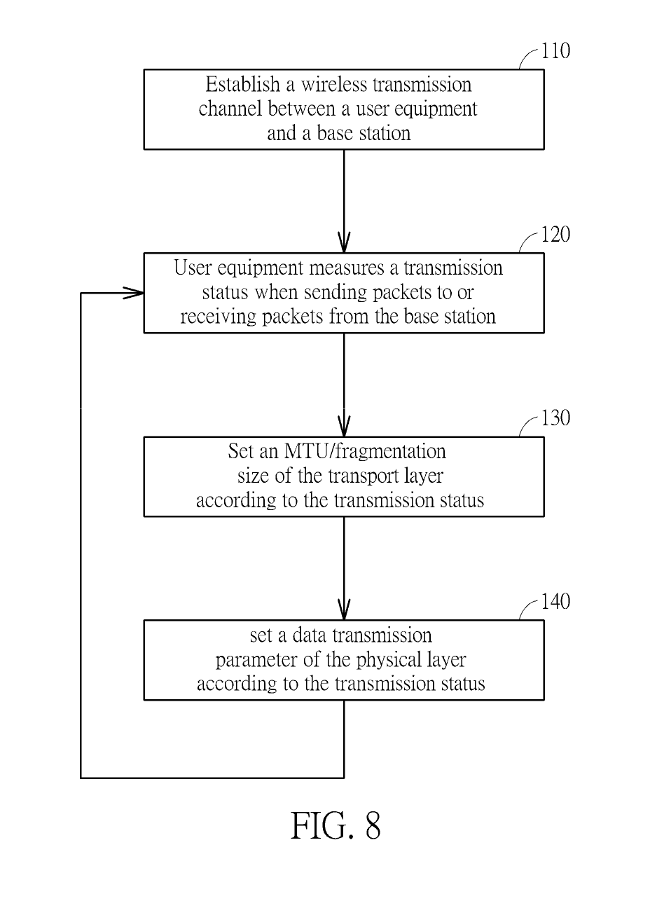

FIG. 8 is a flowchart illustrating a method of optimizing data throughput rate in a wireless network system according to another embodiment of the present invention. The flowchart in FIG. 8 includes the following steps:

Step 110: establish a wireless transmission channel between a user equipment and a base station; execute step 120.

Step 120: user equipment measures a transmission status when sending packets to or receiving packets from the base station; execute step 130.

Step 130: set an MTU/fragmentation size of the transport layer according to the transmission status; execute step 120.

Step 140: set a data transmission parameter of the physical layer according to the transmission status; execute step 120.

In the embodiment illustrated in FIG. 8, the transmission status may be acquired by measuring the packet loss rate or PER of the transport layer in step 120. The data transmission parameter of the physical layer set in step 140 may be the modulation technique adopted by the user equipment.

The MTU/fragmentation size of the transport layer and the data transmission parameter of the physical layer may be set according to the measured packet loss rate or PER in steps 130 and 140, respectively. The following table illustrates an embodiment of setting the MTU/fragmentation size and the data transmission parameter. As well-known to those skilled in the art, BPSK represents binary phase shift keying, QPSK represents quadrature phase shift keying, QAM represents quadrature amplitude modulation, Mbps represents the speed of data transfer in megabits per second, and coding rate is represented in form of A/B in which every A bits of useful data is encoded into B bits of data (A and B are positive integers and A≧B). The arrows represent the directions of adopting the settings ST1-ST19

| | | | | MTU/ | | |
|---|---|---|---|---|---|---|
| | | | | Frag- | | |
| | | | | ment- | Direction | Direction |
| | | Coding | | ation | (PER > | (PER < |
| Setting | Modulation | rate | Mbps | Size | M_{TH}) | M_{TH}) |
| ST1 | BPSK | 1/2 | 15 | 1024 | ↑ | ↓ |
| ST2 | QPSK | 1/2 | 30 | 1248 | | |
| ST3 | QPSK | 3/4 | 45 | 1248 | | |
| ST4 | 16-QAM | 1/2 | 60 | 1248 | | |
| ST5 | 16-QAM | 3/4 | 90 | 1248 | | |
| ST6 | 64-QAM | 2/3 | 120 | 2048 | | |
| ST7 | 64-QAM | 3/4 | 135 | 2048 | | |
| ST8 | 64-QAM | 5/6 | 150 | 2048 | | |
| ST9 | 256-QAM | 3/4 | 180 | 2048 | | |
| ST10 | 256-QAM | 5/6 | 200 | 2048 | | |

For illustrative purpose, assume that the setting ST5 is adopted when step 110 and step 120 is executed at time points T1-T5. In the case that the packet loss rates or PERs measured at T1-T4 exceed the predetermined value, but the packet loss rate or PER measured at T5 does not exceed the threshold value, the settings adopted after T1-T5 are in a sequence of ST4, ST3, ST2, ST1 and ST2. In the case that the packet loss rates or PERs measured at T1-T4 do not exceed the predetermined value, but the packet loss rate or PER measured at T5 exceeds the threshold value, the settings adopted after T1-T5 are in a sequence of ST6, ST7, ST8, ST9 and ST8. In the case the packet loss rates or PERs measured at T1, T2 and T4 exceed the predetermined value, but the packet loss rates or PERs measured at T3 and T5 do not exceed the threshold value, the settings adopted after T1-T5 are in a sequence of ST4, ST3, ST4, ST3 and ST4.

In conclusion, the present invention may provide a method of data transmission in a wireless network system. When a user equipment and a base station in the wireless network system are in communication using a multi-layer structure, the MTU/fragmentation size may be dynamically adjust according to the current transmission status, thereby improving network resource utilization and overall data throughput of the wireless network system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of data transmission between a user equipment and a base station in a wireless network system having a multi-layer structure, comprising:
establishing a wireless transmission channel between the user equipment and the base station;
measuring a signal transmission status of the wireless transmission channel; and
setting a maximum transfer unit (MTU)/fragmentation size adopted in the wireless transmission channel according to the transmission status.

2. The method of claim 1, wherein:
measuring the signal transmission status is measuring a packet loss rate or a packet error rate of the wireless transmission channel.

3. The method of claim 1, wherein setting the MTU/fragmentation size according to the transmission status comprises:
adjusting the MTU/fragmentation size from a first value at a specific time point to a second value smaller than the first value when the transmission status measured at the specific time point is worse than a threshold; and
maintaining the MTU/fragmentation size at the first value when the transmission status measured at the specific time point is not worse than the threshold.

4. The method of claim 1, wherein setting the MTU/fragmentation size according to the transmission status comprises:
adjusting the MTU/fragmentation size from a first value acquired at a specific time point to a second value smaller than the first value when the transmission status measured at the specific time point is worse than a threshold; and
adjusting the MTU/fragmentation size from the first value to a third value larger than the first value when the transmission status measured at the specific time point is not worse than the threshold.

5. The method of claim 4, wherein:
the second value is equal to an average of the first value and a minimum value;
the third value is equal to an average of the first value and a maximum value;
the maximum value is larger than the first value, the second value and the third value; and
the minimum value is smaller than the first value, the second value and the third value.

6. The method of claim 1, further comprising:
acquiring a current value of the MTU/fragmentation size at a specific time;
acquiring an updated value which is smaller the current value;
setting the MTU/fragmentation size to the updated value when the transmission status measured at the specific time point is worse than a threshold and the updated value exceeds a minimum value; and
setting the MTU/fragmentation size to the minimum value when the transmission status measured at the specific time point is not worse than the threshold and the updated value does not exceed the minimum value.

7. The method of claim 1, wherein measuring the signal transmission status is measuring a packet loss rate or a packet error rate of a first layer in the wireless transmission channel, the method further comprising:
setting a data transmission parameter of a second layer in the wireless transmission channel according to the transmission status, wherein the first layer is hierarchically higher than the second layer in the multi-layer structure.

8. The method of claim 7, wherein:
when the transmission status measured at a specific time point is worse than a threshold, the MTU/fragmentation size and the data transmission parameter are set so as to allow the user equipment to operate at a first speed;
when the transmission status measured at the specific time point is not worse than a threshold, the MTU/fragmentation size and the data transmission parameter are set so as to allow the user equipment to operate at a second speed;
the first speed is smaller than a current speed of the user equipment at the specific time point; and
the second speed is larger than the current speed.
